(19) United States
(12) Patent Application Publication
(10) Pub. No.: US 2003/0097448 A1
(43) Pub. Date: May 22, 2003

(54) Server control of hypertext transfer protocol client

(76) Inventors: Francisco Jose Menezes, Paco de Arcos (PT); Miguel Jorge Baltazar, Lisboa (PT); Rui Jorge Coelho, Mem Martins (PT)

Correspondence Address: Jon D. Shutter, Howrey Simon Arnold & White, LLP, P.O. Box 4433, Houston, TX, 77210, US

(21) Appl. No.: 09/990,132

(22) Filed: Nov. 21, 2001

(51) Int. Cl. G06F 15/16

(52) U.S. Cl. 709/227; 709/208

(57) ABSTRACT

A method for controlling an HTTP client comprises the steps of establishing a connection between the HTTP client and a server and sending an event from the server to the HTTP client. The event passes over the HTTP connection and controls the HTTP client. The HTTP server sends the event without receiving a request for the event from the first HTTP client.

### FIELD OF THE INVENTION

The present invention relates generally to controlling a client through the Internet and, in particular, to a server and/or another client controlling the client, such as a browser, using a Hypertext Transfer Protocol.

### BACKGROUND OF THE INVENTION

People use the Internet to perform numerous daily applications, including shopping, banking, bill payment, general research and entertainment. The applications available on the Internet are generally referred to as web applications. Typically, a user accesses web applications using a browser on their personal computer. The browser is an application program that provides a way to view and interact with the information on the World Wide Web.

Generally, the browser is a client program that uses a Hypertext Transfer Protocol (“HTTP” hereinafter) to make requests to web servers throughout the Internet on behalf of the user. The web server is a program that uses the Hypertext Transfer Protocol to send the files that form web pages to the browser. HTTP is an application protocol comprising a set of rules for exchanging files, such as text, graphic images, sound, video, and other multimedia files on the World Wide Web. Briefly, the HTTP consists of the browser generating and sending a request message to the server. When the user types in a Uniform Resource Locator or clicks on a hypertext link, the browser generates and sends the HTTP request message. Next, the server receives the HTTP request and after any necessary processing, responds to the HTTP request. In response, the server provides the files that form requested web page. Lastly, after the browser has received the request web materials from the server, the browser displays the web materials. Simply, the Hypertext Transfer Protocol is a connectionless protocol based on a request-response flow; that is, the browser only receives a response if it has made a request.

Due to the large number of diverse web applications, users performing operations and transactions on the Internet face a multitude of different user interfaces, namely, different web pages with varying links. For example, the user shopping at different web sites experiences different paths to navigate on each site such as numerous pull-down menus, varying hypertext links and different order forms to complete. The lack of a single, standard user interface for all web applications makes the web applications difficult and confusing for some users. This difficulty and confusion sometimes results in the user being unable to perform the desired operations or view the desired material on the web site. The frustrated user may quit the web application without completing their desired task, such as purchasing merchandise offered on the web site.

Unlike traditional software, most conventional web applications do not offer a technical support hotline. Without the technical support hotline, the user cannot call a technical support agent for an explanation on how to access or perform the web application. Rather than being able to rely on expert assistance, the user typically attempts to solve the problem using trial-and-error methods or using any in-site help documentation. The in-site help documentation often comprises a written description listing a series of steps to perform for the web application. The steps are often numerous and confusing to the typical user preventing them from readily completing the desired task.

Even if the web site has a traditional technical support telephone hotline, the user must articulate their confusion and pin point the exact location of their problem. The technical support agent may not be able to readily determine the problem from the user's verbal description. The diversity and complexity of some web applications makes it extremely difficult for the agent to identify the specific page location or other contextual factors that confuse the user. Moreover, the typical user may only have one phone line that is being used for their Internet connection. This prevents the agent from talking the user through the web application as the user performs the steps described on the telephone. The typical user must disconnect from the web site, make the telephone call to the technical support center, describe their problem, listen to the verbal instructions, end the telephone call, then log back onto the web site and perform the steps described by the agent. During this process, the user may forget the instructions and may still be unable to perform the desired web application.

In addition to the telephone technical support hotline, some web sites provide technical assistance through email. Similar to the problems with telephone communications, the user may be unable to articulate their confusion and pin point the exact location of the problem with an email message. The technical support agent may not be able to determine the user's problem from the user's email. Moreover, the user may not be patient enough to wait several minutes for a reply email.

The user's confusion with the web application harms the owner of the web application. For the typical shopping or e-commerce web application, the customer navigates the website to find a desired item. If the customer gives up looking for the item, a sale is lost. Even if the customer finds the desired item, the customer must then fill out a form to complete a purchase. If the purchase form is somewhat complicated and the on-site help does not provide clear guidance, the customer may be unable or unwilling to complete the form. As a result, the customer decides not to make a purchase, and the owner of the web application loses a customer.

Thus, there is a need for a system that provides assistance for web applications. If the customer is having difficulty with the web application, the system should identify the customer's problem and provide a solution. The system should allow remote control of the customer's browser and allow information to be sent to the customer's browser without the customer's browser requesting the information. The system should allow a customer service agent to view the same web page as the customer and to communicate with the customer to provide help. The system should also allow the service agent to lead the customer through the web application and assist with any form filling.

### SUMMARY OF THE INVENTION

According to one aspect of the present invention, there is provided a method for controlling a first HTTP client. The method comprising establishing a first HTTP connection between the first HTTP client and an HTTP server and sending an event to the first HTTP client from the HTTP server without the first HTTP client requesting the event from the HTTP server. The event may comprise an HTTP response with text to be displayed by the first HTTP client or an URL of a web page to be displayed by the first HTTP client. The first HTTP client processes the event. For the step of establishing the HTTP connection, the first HTTP client requests the connection and the HTTP server answers the request, such as by sending a multi-part document HTTP response. The HTTP connection may pass through the Internet, and the event may pass through a proxy server and firewall. The method may further include establishing a second HTTP connection between the HTTP server and a second HTTP client and sending a second event from the second HTTP client to the first HTTP client. The method of controlling the first client by the server may be used for management and support of web application usage and for educational training.

According to another aspect of the present invention, there is provided a method for remotely controlling a first HTTP client by a second HTTP client. The method comprises establishing an HTTP connection between the first HTTP client and the second HTTP client and sending an event from said second HTTP client to said first HTTP client. The HTTP connection comprises a first HTTP connection between the first HTTP client and a server and a second HTTP connection between the second HTTP client and the server. The event comprises an HTTP request portion and an HTTP response portion. The event causes the first HTTP client to perform an action. The event may include text to be displayed by the first HTTP client and a URL of a web page to be displayed by the first HTTP client. The second HTTP client may act as a host and send several events to control the first HTTP client. Additionally, the first HTTP client may send events to the second HTTP client. The method for remotely controlling a first HTTP client by a second HTTP client allows real time information exchange between the clients and may be used for management and support of web applications.

According to a further aspect of the present invention, there is provided a method for providing web site assistance for a customer browser. The method comprises establishing a first connection between the customer browser and a server, establishing a second connection between the server and an agent browser, and sending an event from the agent browser to the customer browser that controls the customer browser. The connections between the customer browser and agent browser pass through the Internet. The event is sent from the agent browser to the server and then to the customer browser. The server processes an HTTP request portion of the event and passes an HTTP response portion of the event to the customer browser. The event may include text to be displayed by the customer browser or a URL of a web page to be displayed by the customer browser. The method may further include the step of the customer browser sending a second event to the agent browser. The events between the agent browser and customer browser may be web chat messages. Additionally, the events between the agent browser and customer browser may be URLs for a co-browsing session.

According to another aspect of the present invention, there is provided a method for pushing a web page to a customer browser. The method comprises creating a first connection between the customer browser and a server, creating a second connection between the server and an agent browser, sending an event comprising a URL of the web page displayed on the agent browser to the customer browser, and processing the event causing the customer browser to request the URL and display the web page. The method may further include the steps of performing an action on the web page by the agent browser, sending a second event comprising the action from the agent browser to the customer browser and processing the second event to display the action on the customer browser. Moreover, the method may include the steps of performing an action on the web page by the customer browser, sending a third event comprising the action from the customer browser to the agent browser and processing the third event to display the action on the agent browser. The method for pushing a web page is particularly useful for co-browsing and implementing a form filling session.

According to another aspect of the present invention, there is provided a method for pulling a web page from a customer browser. The method comprises creating a first connection between the customer browser and a server, creating a second connection between the server and an agent browser, sending a first event to the customer browser, processing the first event causing the customer browser to generate a second event comprising a URL of the web page, sending the second event from the customer browser to the agent browser, and processing the second event by the agent browser causing the agent browser to go to request the URL and display the web page. The method may further include the steps of performing an action on the web page by the agent browser, sending a third event comprising the action from the agent browser to the customer browser and processing the third event to display the action on the customer browser. Moreover, the method may include the steps of performing an action on the web page by the customer browser, sending a fourth event comprising the action from the customer browser to the agent browser and processing the fourth event to display the action on the agent browser. The method for pulling a web page is particularly useful for co-browsing and implementing a form filling session.

According to a further aspect of the present invention, there is provided a system for controlling a first client. The system comprises a server capable of establishing a connection with the first client and sending an event to the first client without the first client requesting the event. The event controls the first client, and in one embodiment, the event is an HTTP response that the first client processes. The server establishes the connection between the first client and the server by answering a connection request from the first client. The server's answer to the connection request may be a multi-part HTTP response. The server is also capable of receiving a second event from the first client. The server is further capable of establishing a second connection with a second client and receiving a second event from the second client. The server passes the second event to the first client to allow the second client to control the first client.

### BRIEF DESCRIPTION OF THE DRAWINGS

Other aspects and advantages of the invention will become apparent upon reading the following detailed description and upon reference to the drawings.

FIG. 1 is a block diagram of a system with a server controlling a client according to one embodiment of the present invention;

FIG. 2 is a flow chart of the operations of the system in FIG. 1;

FIG. 3 is a block diagram of the system of FIG. 1 including a proxy server and firewall;

FIG. 4 is a block diagram of a system with a second client controlling a first client according to another embodiment of the present invention;

FIG. 5 is a flow chart of the operations of the system in FIG. 4;

FIG. 6 is a block diagram of a system with several clients controlling each other according to a further embodiment of the present invention;

FIG. 7 is a flow chart of the operations of a client;

FIG. 8 is a flow chart of the operations of a server;

FIG. 9 is a screen capture of a web page for establishing web chat and co-browsing;

FIG. 10 is a screen capture of a portion of a web page illustrating web chat; and

FIG. 11 is a screen capture of a web page illustrating co-browsing.

While the invention is susceptible to various modifications and alternative forms, specific embodiments thereof have been shown by way of example in the drawings and are herein described in detail. It should be understood, however, that the description herein of the specific embodiments is not intended to limit the invention to the particular forms disclosed, but on the contrary, the intention is to cover all modifications, equivalents, and alternatives falling within the spirit and scope of the invention as defined in the appended claims.

### DESCRIPTION OF ILLUSTRATIVE EMBODIMENTS

Turning now to the drawings and referring initially to FIG. 1, there is depicted a system 10 with a server 12 capable of controlling a client 14 according to one embodiment of the present invention. The client 14 may be any application program or code operating on a computer that implements an HTTP client. That is, the client 14 may be any client software program or code on a computer that generates Hypertext Transfer Protocol requests. A communication link 16 connects the client 14 to the Internet 18 using any kind of link, such as a dial-up link, a private line, a public line or a wireless link. The server 12 may be any application program or code operating on a computer that implements an HTTP server. That is, the server 12 may be any software program or code on a computer that accepts HTTP requests and generates HTTP responses. Like the client 14, the server 12 is also connected to the Internet 18 with a communication link 20 that may be any kind of link including a dial-up link, a private line, a public line or a wireless link. Although FIG. 1 depicts the server 12 and client 14 connected through the Internet 18, in another embodiment, the client 14 may be connected to the server 12 through a local network and communications between the server 12 and client 14 travel through the local network without passing through the Internet.

Returning to the embodiment illustrated in FIG. 1, once the communication links 16 and 20 are established to the Internet 18, the client 14 may request from the server 12 web pages that comprise text, graphic images, sound, video, and other multimedia files. To request the web pages, the client 14 generates and sends an HTTP request message to the server 12. Next, the server 12 receives the HTTP request and, after any necessary processing, responds to the HTTP request. In responding to the request, the server 12 sends and HTTP response including the files that form requested web page to the client 14.

In addition to the client 14 requesting web pages from the server 12, the system 10 allows the server 12 to send an event 22 to control the client 14. In accordance with the present invention, an HTTP connection is established between the server 12 and the client 14. The HTTP connection is a transport layer virtual circuit established between the HTTP server software and the HTTP client software that may be placed anywhere in the Internet or local network. The HTTP is a connectionless protocol based on a request-response flow. That is, the HTTP client, such as a browser, only receives a response if it made a request. The system 10 of the present invention simulates a connection protocol on top of the connectionless HTTP by making a response from the server 12 to the client 14 that never seems to end.

Once the HTTP connection is established, the system 10 allows the server 12 to send events 22 to the client 14. An event is an asynchronous message sent by the server 12 and received by the client 14. In one embodiment, the event 22 is an HTTP response from the server 12 that is received as an HTML document including the scripts that are used to control the client 14. Events 22 may include any type of file or any instruction, such as files that comprise web page content not necessarily a whole web page. For example, the server 12 may send text for only a small field on the web page. When the client 14 receives the event 22, the client 14 performs the event 22. For example, when the browser receives the event, the browser displays the supplied text in the designated field.

Instead of having the master-like client making requests for web pages from the slave-like server 12, the present invention allows the server 12 to control the web materials sent to and viewed by the client 14 without receiving requests from the client 14 for those web materials. The following Table 1 illustrates the difference between the typical HTTP request-response and one embodiment of the present invention that allows the server 12 to send events 22 without being requested by the client 14.

TABLE 1

| Typical HTTP Request- | |
|---|---|
| Respond | Server Control Without Request |
| 1. Browser requests a page | 1. Browser requests a page from |
| from the Server by opening a | the Server by opening a socket |
| socket and sending: | and sending: |
| GET/iv/pusher HTTP/1.1 | GET/iv/pusher HTTP/1.1 |
| Accept-Language: pt | Accept-Language: pt |
| Accept-Encoding: gzip, | Accept-Encoding: gzip, deflate |
| deflate | User-Agent: Mozilla/4.0 (compatible; |
| User-Agent: Mozilla/4.0 | MSIE 5.5; Windows NT 5.0) |
| (compatible; MSIE 5.5; | Host: dublin:3333 |
| Windows NT 5.0) | Connection: Keep-Alive |
| Host: dublin:3333 | |
| Connection: Keep-Alive | |
| 2. Server responds to the | 2. Server responds to the request |
| request by returning: | by returning a multi-part |
| HTTP/1.1 200 OK | document: |
| Date: Mon, 17 Sep. 2001 | HTTP/1.1 200 OK |
| 14:38:00 GMT | Date: Mon, 17 Sep. 2001 |
| Server: Apache/1.3.12 (Unix) | 14:38:00 GMT |
| Last-Modified: Thu, 22 | Server: Webpusher/1.0 |
| Feb. 1996 11:46:04 GMT | Keep-Alive: timeout=15, max=96 |
| Accept-Ranges: bytes | Connection: Keep-Alive |
| Content-Length: 225 | Content-Type: |
| Keep-Alive: timeout=15, | multipart/mixed;boundary=pusherScripts |
| max=96 | --pusherScripts |
| Connection: Keep-Alive | Content-type: text/html |
| Content-Type: text/plain | <HTML> . . . </HTML> |
| <HTML> . . . </HTML> | --pusherScripts |
| 3. Browser may make further | 3. Server sends an event to the |
| requests and server waits for | browser without the browser |
| further requests. | requesting it first. In the same socket |
| | the Server sends: |
| | --pusherScripts |
| | Content-type: text/html |
| | <HTML> . . . </HTML> |
| | --pusherScripts |

For the example of Table 1, the client 14 is a browser. For the typical HTTP request-response example provided in the first column of Table 1, the browser requests a web page from the server by opening a socket and sending an HTTP request. Next, the server responds to the HTTP request by returning an HTTP response including an HTML document. After this request-response, the browser may again request web pages from the server, and the server waits for additional requests. For the server control without request example provided in the second column of Table 1, the browser first makes a request to the server by opening a socket and sending an HTTP request similar to the first step of the typical HTTP request-respond example. Next, the server responds to the HTTP request by returning an HTTP response including a multi-part document. The multi-part document provides the HTTP connection as discussed above. Now the server can send another event, such as the “<HTML> . . . </HTML>” event in the example, without the browser requesting it first.

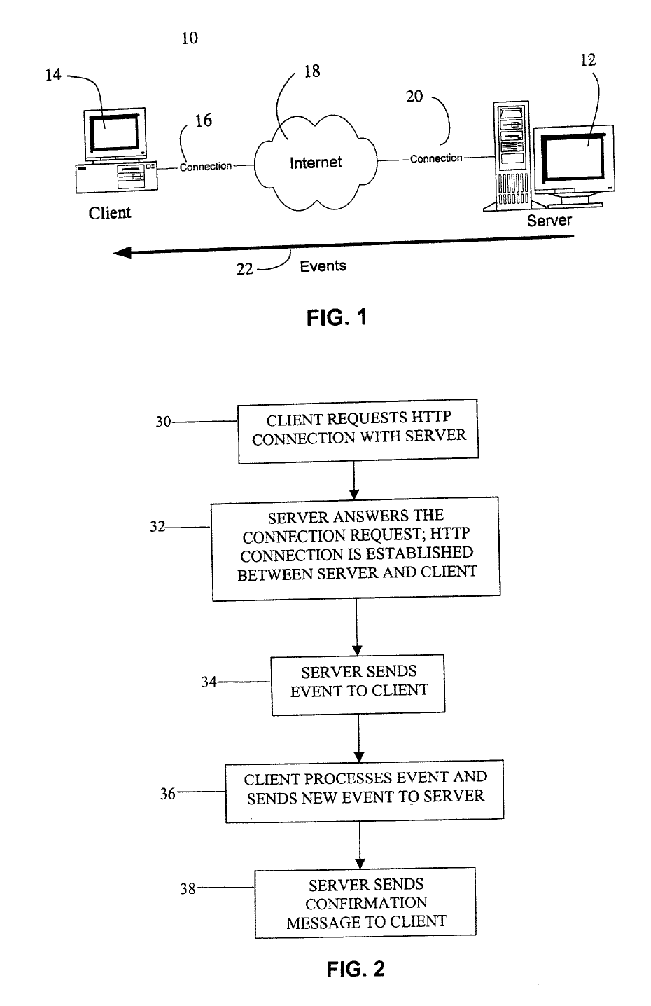

FIG. 2 illustrates a flowchart of the operations of the system 10 with the server 12 controlling the client 14 according to one embodiment of the present invention. At step 30, the client 14 requests an HTTP connection with the server 12. To make the HTTP connection, the client 14 sends an HTTP request connection message to the server 12 via the communication links 16, 20 and the Internet 18. Once the server 12 receives the HTTP connection request, the server 12 answers at step 32 by sending an HTTP confirmation message back to the client 14. In one embodiment, the confirmation message comprises an HTTP response with a multi-part document that will be used as the HTTP connection and will be kept open by the server 12 in order to provide an asynchronous connection between the server 12 and client 14. To avoid the connection to close, such as by a browser timeout, the server 12 periodically refreshes the response or sends content, such as the confirmation message or simply an empty line in an HTTP response.

Once the HTTP connection between the server 12 and client 14 is established, the server 12 sends the event 22 to the client 14 at step 34. Once the client 14 receives the event 22, a predefined action sequence commences on the client 14 to complete the event 22. As a result of processing the received event, the client 14 sends a new event to the server 12 at step 36. After receiving the new event, the server 12 responds with a confirmation message insuring the client 14 that the new event was properly delivered at step 38. The server 12 may issue several events 22 over the HTTP connection. The following Table 2 is an example of code for the server 12 sending an event 22 to the client 14 following the steps described in conjunction with FIG. 2. In the code example of Table 2, the event 22 comprises a text message useful for web chat as will be described in detail below.

TABLE 2

| Client to Server | Server to Client |
|---|---|
| Step 30 -- Client requests a | |
| connection (note that 1232432 is a | |
| timestamp to avoid the Browser | |
| cache): | |
| GET/iv/pusher/1232432/connect | |
| Cookie: wc_session=121212 | |
| Cookie: wc_userid=454545 | |
| | Step 32 -- Server answers the connection request: |
| | HTTP/1.0 200 Data follows |
| | Date: Mon, 20 Sep. 1999 11:12:50 GMT |
| | Server: webpush/1.0 |
| | Set-Cookie: wc_session=121212; path=/ |
| | Set-Cookie: wc_userid=454545; path=/ |
| | Content-Type: multipart/mixed;boundary=pusherScripts |
| | --pusherScripts |
| | Content-type: text/html |
| | <script language=”JavaScript”> |
| | document.cookie=”wc_session=121212; |
| | wc_userid=454545”; |
| | </script> |
| | --pusherScripts |
| | Step 34 -- Server sends an event (a chat message in this |
| | case): |
| | --pusherScripts |
| | Content-type: text/html |
| | <script language=”JavaScript”> |
| | iv_chatMessage(“peter”,“Hello, how are you ?”); |
| | </script> |
| Step 36 -- Client sends an event (a | |
| page synchronization in this case): | |
| POST/iv/pusher/345667/send | |
| Cookie: wc_session=121212 | |
| Cookie: wc_userid=454545 | |
| script=iv_pushPage(“http://www.site. | |
| com/”)&confirm=true&req_id= | |
| 233445 | |
| | Step 38 -- Server confirms reception of the event: |
| | --pusherScripts |
| | Content-type: text/html |
| | <script language=”JavaScript”> |
| | iv_confirm( ); |
| | </script> |

The system 10 allows real-time information exchange between the server 12 and the client 14. Unlike the regular polling method used by conventional web browsers that get content from servers on demand or on a regular basis, the system 10 provides asynchronous real time communications between the server 12 and the client 14. Additionally, the system 10 allows information exchange between the server 12 and the client 14 without having to reload a web page from the web application. Because the system 10 allows the server 12 to send an event that changes only part of the page, reloading is unnecessary. Thus, the system 10 provides the ability to send irregular information to the client 14. For example, the server 12 may send news feeds, such as stock information or weather reports, and an on-line presence, such as an instant messages used to notify other users when someone goes on-line/off-line, without being requested by the client 14.

Additionally, the system 10 allows a connection to a client, such as a browser, through which a remote server can control what the browser displays. This remote control enables the remote server to guide the browser to a new page location, push additionally information to the browser and modify part of the displayed page with new information. Furthermore, the system 10 allows information exchange between the remote server and the browser to take place based on actions the user takes upon a web application page without a request to the web application. For example, filling a field in a form of the web application causes the server to send an event to another browser involved in a collaborative form filing session without any request to the web application.

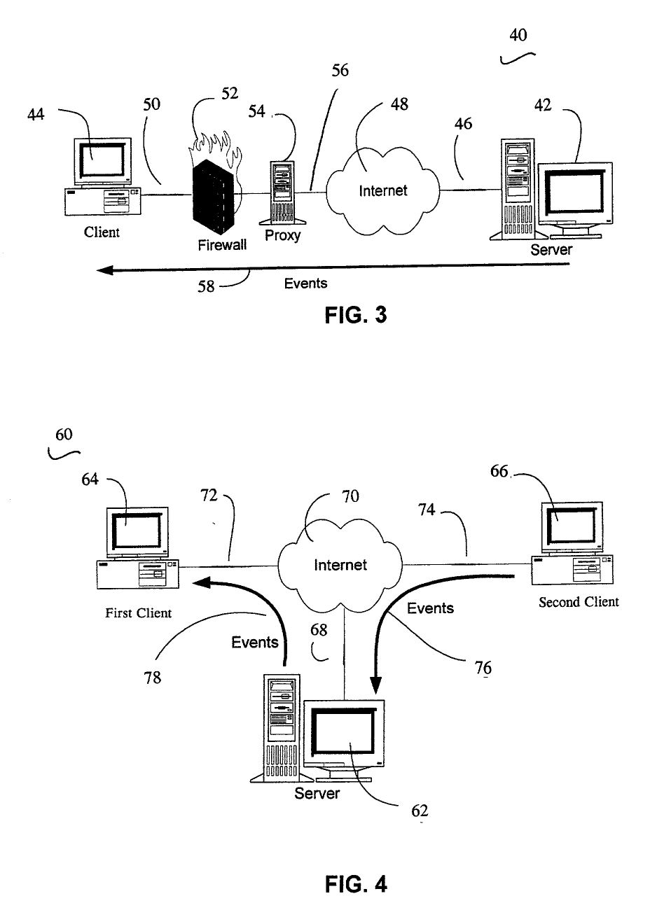

FIG. 3 illustrates a system 40 with a server 42 capable of controlling a client 44 according to another embodiment of the present invention. Like the system 10 of FIG. 1, the server 42 is an HTTP server and the client 44 is an HTTP client. A communication link 46 connects the server 42 to the Internet 48 using any kind of link, such as a dial-up link, a private line, a public line or a wireless link. The client 44 is also connected to the Internet 48; however, the client's communication link 50 connects the client 44 to a firewall 52 and a proxy server 54 before a communication link 56 connects the proxy server 54 to the Internet 48. The communication links 50, 56 between the client 44, proxy server 54 and the Internet 48 may be any kind of link including a dial-up link, a private line, a public line or a wireless link.

Briefly, an enterprise may have a private local network through which the client 44 may access the Internet 48. The proxy server 54 is a server that acts as an intermediary between the client 44 and the Internet 48 so that the enterprise can ensure security and administrative control. The proxy server 54 is associated with or part of a gateway server (not shown) that separates the enterprise network from the outside Internet 48. The firewall 52 is a set of related programs located at the gateway server that protects the resources of the private enterprise network from outside intrusion. For the purposes of this discussion, the firewall 52 and proxy server 54 are part of the same gateway server. Generally, the proxy server 54 receives a request for a web application, such as an HTTP request for a web page, from the client 44. If the request passes filtering requirements, the proxy server 54, acting on a client on behalf of the client 44, requests the web page from the server 42 over the Internet 48. When the web page is returned, the proxy server 54 forwards it to the client 44. To the client 44, the proxy server 54 appears to be invisible.

Returning to FIG. 3, once the communication links 46, 50 and 56 are established, the client 44 may request web pages from the server 42. To request the web pages, the client 44 generates and sends an HTTP request message that is received by the proxy server 54. The proxy server 54 then acts on behalf of the client 44 and requests the web page from the server 42. Next, the server 42 receives the HTTP request and, after any necessary processing, responds to the HTTP request. In responding to the request, the server 42 sends an HTTP response with the files that form the requested web page to the proxy server 54 that are passed through to the client 44.

In addition to the client 44 requesting files from the server 42, the system 40 allows the server 42 to send events 58 to control the client 44. In accordance with the present invention, an HTTP connection is established between the server 42 and the client 44. As described above, the HTTP connection is a transport layer virtual circuit established between the HTTP client software and the HTTP server software that may be placed anywhere in the Internet. The HTTP is a connectionless protocol based on a request-response flow. That is, the HTTP client, such as a browser, only receives a response if it made a request. The system 40 of the present invention simulates a connection protocol on top of the connectionless HTTP by making a response from the server 42 to the client 44 that never seems to end. In one embodiment, the server 42 provides a multi-part document in its HTTP response to form the HTTP connection. Because the system 40 includes the proxy server 54, the HTTP connection comprises a first HTTP connection established between the server 42 and the proxy server 54, and a second HTTP connection established between the proxy server 54 and the client 44.

Once the HTTP connection is established, the system 40 allows the server 42 to send events 58 to the client 44 through the proxy server 54. In one embodiment, the event 58 is an asynchronous message in the form of an HTTP response from the server 42 that is received as an HTML document including the scripts that are used to control the client 44. Events 58 may include any type of file or any instruction, such as files that comprise the web page but not necessarily a whole web page. For example, the server 42 may send text for only a small field on the web page. When the client 44 receives the event 58, the client 44 performs the event 58.

The operations of the system 40 are similar to those described in conjunction with FIG. 2. Briefly, the client 44 first requests the HTTP connection with the server 42. The client 44 sends an HTTP connection message to the server 42. The proxy server 54 receives the HTTP connection message from the client and passes the message to the server 42 via the Internet 48. Once the server 42 receives the HTTP connection request, the server 42 answers by sending an HTTP confirmation message back to the client 42 directed through the proxy server 54. In one embodiment, the HTTP confirmation message comprises an HTTP response with a multi-part document. The proxy server 54 receives the confirmation message and forwards it to the client 44. The confirmation message will be used as the HTTP connection that will be kept open to provide an asynchronous connection between the server 42 and the client 44 through the proxy server 54.

Once the HTTP connection between the server 42 and client 44 through the proxy server 54 is established, the server 42 sends the event 58 to the client 44. The proxy server 54 receives the event 58 and passes to the client 44 through the firewall 52 if security restrictions are met. Once the client 44 receives the event 58, a predefined action sequence commences on the client 44 to complete the event 58. As a result of processing the received event 58, the client 44 sends a new event to the server 42 over the HTTP connection through the proxy server 54. After receiving the new event, the server 42 responds with a confirmation message insuring the client 44 that the new event was properly delivered.

By using the Hypertext Transfer Protocol, the server 42 may send events 58 through the proxy server 54 and/or firewall 52. Once the HTTP connection is made between the server 42 and client browser 44 through the proxy server 54, the server 42 may send events to change the contents and properties of the client 44, provided the security restrictions configured in the proxy server 54 and/or firewall 52 are met. Conventional security restrictions provide that the firewall may not allow connections to any other port, any other machine or in any other protocol other than the proxy server machine in a default port using HTTP. The present invention allows the server 42 to send events to control the client 44 while meeting these conventional security restrictions.

Because the protocol between the server 12, 42 and the client browser 14, 44 is the Hypertext Transfer Protocol, any client code operating on a client computer that can provide the HTTP protocol may connect to the server 12, 42. Some example of HTTP client codes include Java applets, ActiveX components, browsers, such as Microsoft Internet Explorer and Netscape Navigator, or any software plug-ins that implement an HTTP client. For FIGS. 1 and 3, the client 14 and 44 may be replaced with any client code that implements the HTTP client.

FIG. 4 illustrates a system 60 with a second client 66 capable of controlling a first client 64 according to another embodiment of the present invention. The first and second clients 64, 66 may be any application program or code on a computer that implements an HTTP client. That is, the clients 64, 66 may be any client software program or code on a computer that generates Hypertext Transfer Protocol requests. The server 62 may be any application program or code operating on a computer that implements an HTTP server. That is, the server 62 may be any software program or code on a computer that accepts HTTP requests and generates Hypertext Transfer Protocol responses. A communication link 68 connects the server 62 to the Internet 70 using any kind of link, such as a dial-up link, a private line, a public line or a wireless link. A communication link 72 connects the first client 64 to the Internet 70 using any kind of link, such as a dial-up link, a private line, a public line or a wireless link. Similarly, a communication link 74 connects the second client 66 to the Internet 70 using any kind of link, such as a dial-up link, a private line, a public line or a wireless link. In another embodiment, a proxy server and/or firewall may be present in all of the above connections 68, 72, 74. Although FIG. 4 illustrates the server 62 and clients 64, 66 connected through the Internet 70, the server 62 and clients 64, 66 may also be connected to each other through a local network.

Once the communication links 68, 72 and 74 are established to the Internet 70, the first client 64 and the second client 66 may request web pages from the server 62. To request the web pages, the clients 64, 66 generate and send an HTTP request message over the Internet to the server 62. Next, the server 62 receives the HTTP request and, after any necessary processing, responds to the HTTP request. In response to the request, the server 62 sends the files for the requested web page to the client 64, 66.

In addition to the clients 64, 66 requesting Web pages from the server 62, the system 60 allows the second client 66 to control the first client 64. In accordance with the present invention, an HTTP connection is established between the first client 64 and the server 62 and another HTTP connection is established between the second client 66 and the server 62. The HTTP connection is a transport layer virtual circuit established between the HTTP client software and the HTTP server software that may be placed anywhere in the Internet. The HTTP is a connectionless protocol based on a request-response flow. That is, the HTTP client, such as a browser, only receives a response if it made a request. The system 60 of the present invention simulates a connection protocol on top of the connectionless HTTP by making a response from the server 62 to the first client 64 and from the server 62 to the second client 66 that never seems to end. In one embodiment, the server 62 provides a multi-part document in its HTTP response to form the HTTP connection.

Once the HTTP connections between the server 62 and the first and second clients 64, 66 are established, the system 60 allows the second client 66 to send an event 76 to the server 62. The server 62 receives and processes the event 76 and then sends an event 78 to the first client 64. The event 78 from the server 62 to the first client is in the form of an HTTP response, and the event 76 from the second client 66 to the server just adds an HTTP request on top of that HTTP response. Events are asynchronous messages. In one embodiment, the first client 64 receives the event 78 as HTML document, including the scripts that control the first client 64. Events may include any type of file or any instruction. When the first client 64 receives the event 78, the first client 64 performs the event 78, such as displaying the supplied text in the designated field.

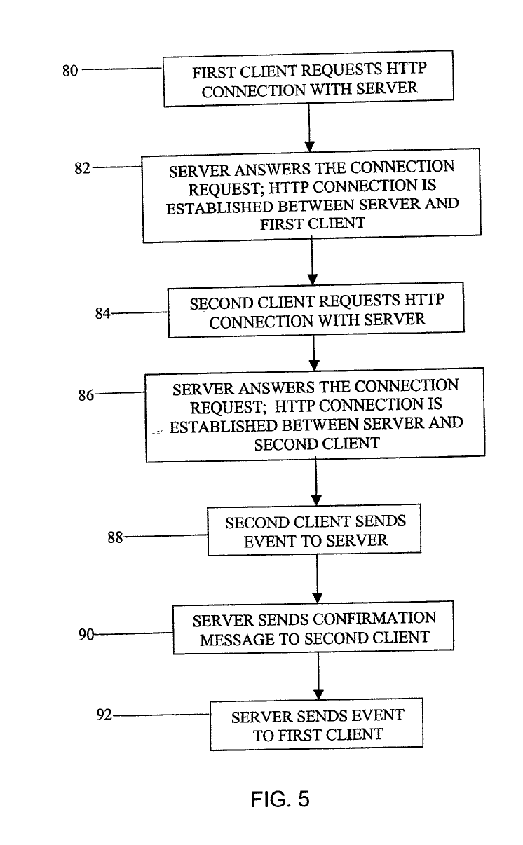

FIG. 5 illustrates a flow chart of the operations of one embodiment of the system 60 having the second client 66 controlling the first client 64. At step 80, the first client 64 requests an HTTP connection with the server 62. To make the HTTP connection, the first client 64 sends an HTTP request connection message to the server 62. Once the server 62 receives the HTTP connection request, the server 62 answers at step 82 by sending an HTTP confirmation message back to the first client 64. This confirmation message will also be used as the HTTP connection that will be kept open by the server 62 in order to provide an asynchronous connection between the server 62 and first client 64. At step 84, the second client 66 requests an HTTP connection with the server 62. To make the HTTP connection, the second client 66 sends an HTTP connection request message to the server 62. Once the server 62 receives the HTTP connection request, the server 62 answers step 86 by sending an HTTP confirmation message back to the second client 66. This confirmation message will also be used as the HTTP connection that will be kept open by the server 62 in order to provide an asynchronous connection between the server 62 and second client 66.

Once both clients 64 and 66 have established the HTTP connections with the server 62, the second client 66 sends the event 76 to the server 62 at step 88. Once the server 62 receives the event, the server 62 responds by sending a confirmation message back to the second client 66 at step 90. After any necessary processing of the event, the server 62 sends the event 78 to the first client 64 at step 92. Once the first client 64 receives the event 78, a predefined action sequence commences on the first client 64 to complete the event. The second client 66 may issue several events 76 to the server 42 that in turn issues several events 78 to the first client 64 repeating steps 88, 90 and 92. Below, Table 3 is an example of code for the second client 66 sending an event to the first client 64 following the steps described in conjunction with FIG. 5. In the code example of Table 2, the event comprises a text message useful for web chat as will be described in detail below.

The system 60 allows real time information exchange between the second client 66 and the first client 64. Additionally, the system 60 allows information exchange between the second client 66 and the first client 64 without having to reload a web page. Because the system 60 allows the second client 66 to send the event that changes only part of the page, reloading is unnecessary. Thus, the system 60 provides the ability to send irregular information to the first client 64. Moreover, the system 60 allows the second client 66 to control what the first client 64 displays. This remote control enables the remote second client 66 to guide the first client 64 to a new page location, push additionally information to the first client 64 and modify part of the displayed page with new information.

In one embodiment of the system 60, the second client 66 acts as a host client sending events to control the first client 64. Using the system 60, the host client 66 can control the first client 64 regardless of where the host client 66 and first client 64 are located. Additionally, the host client 66 can control the first client 64 regardless of the host's and first client's type of connection to the Internet. All of the communications between the host client 66 and the first client 64 are made through the server 62. For example, if the first client 64 is a browser, the host client 66 can control the first browser 64 by sending events, such as pushing Web pages to be displayed on the first browser 64. Likewise, the host client 66 can guide the first browser 64 through any necessary operation on the web application by sending events that provide a demonstration on the first browser 64. This web guidance can be a dynamic demonstration that allows the user of the first browser 64 to act upon. By providing the events, such as certain web pages, to the first browser 64, the host 66 can insure that the user of the first browser 64 is viewing material sent by the host 66 instead of randomly surfing the Internet. Thus, the system 60 provides web application management and/or support. Moreover, the system 60 may be used for educational training and demonstrations.

In another embodiment of the system 60, the role of the first and second clients 64 and 66 is symmetric. That is, not only does the second client 66 send events to the first client 64 through the server 62, but the first client 64 also sends events to control the second client 66 through the server 62. With both clients 64, 66 sending events, the system 60 allows information exchange between the two clients 64, 66 regardless of the location or type of Internet connection of either client 64, 66. All of the communications between the clients 64, 66 are made through the server 62. The system 60 provides a way for users to share the same browser contents, granting a way for one of the users to control what the other user is seeing in a given web application, either by changing the entire web application screen or just part of it.

In one embodiment of the system 60, the system 60 allows the control of the first client 64 regardless of the connection type, including a browser connection, a Java applet, or a browser add-on. The connection can be used either to receive or send events. This application of the system 60 is particularly useful for applications that are not browsers. For example, a standard application can be extended to implement an HTTP client by adding a plug-in that gives the application the ability to communicate with the HTTP protocol. The system 60 allows information to be exchanged between that application (first client 64) and a common browser (second client 66). The system 60 enables control and/or monitoring of that application (first client 64) with a standard browser (second client 66). For example, the system 60 permits a database administrator to access real time monitoring of a database supporting the HTTP protocol from any location with a computer that offers access to the Internet.

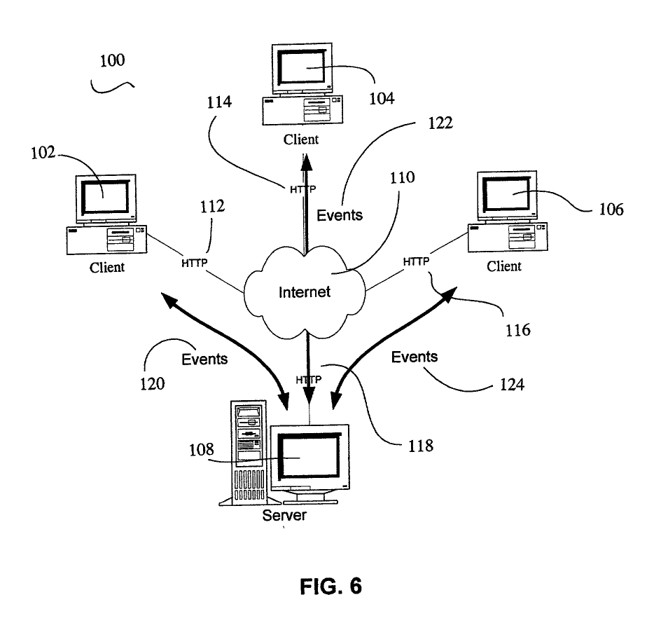

FIG. 6 illustrates a system 100 according to another embodiment of the present invention. In the system 100, several clients 102, 104, 106 are capable of controlling each other. Similar to the system 60 shown in FIG. 4, the clients 102, 104, 106 and server 108 connect to the Internet 110. For brevity, each of the clients 102, 104, 106 and server 108 have established HTTP connections 112, 114 and 116 respectively in the manner described above. A proxy server and/or firewall may be present in all of the connections 112, 114, 116. Once the HTTP connections are made, one client, such at the first client 102, sends an event to the server in the form of an HTTP request on top of an HTTP response. When the server 108 receives the first client's event 120, the server 108 processes the event and then may distribute it to the second client 104 and/or the third client 106 and even back to the first client 102 in the form of an HTTP response. The server 108 sends the event through the respective HTTP connections with the clients 102, 104, 106. Depending on the event destination, the event is either redirected to the second client's HTTP connection 114 as event 122 and/or the third client's HTTP connection 116 as event 124. Finally, the second client 104 and/or third client 106 receive and process the event 122, 124.

In one embodiment of the system 100, one of the clients may act as a host client to control the other clients. For example, the first client 102 may issue events to control the second client 104 and third client 106 and/or many other clients having the HTTP connection to the server 108. This embodiment is useful in a training context to provide training examples to the various clients. In another embodiment, any of the clients 102, 104, 106 may control each other in symmetric roles. That is, the client 102 may send events to clients 104, 106. The client 104 not only receives events but also may send events to the other clients 102, 106. Additionally, the client 106 not only receives events but may also send events to the other clients 104, 106. This example may serve as a conference room for clients to exchange information and ideas.

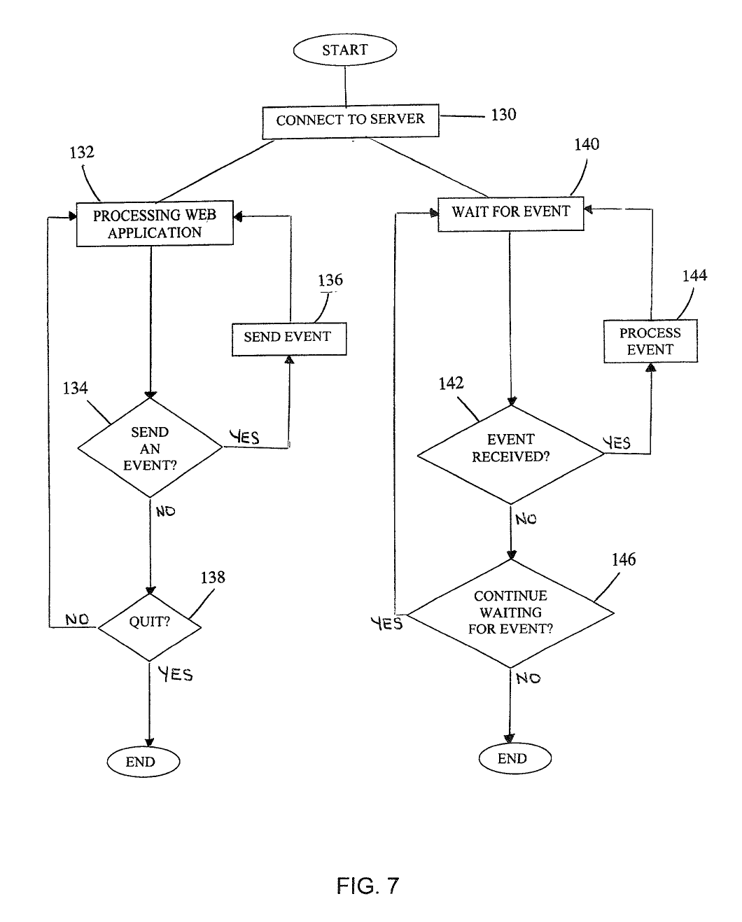

FIG. 7 illustrates a flow chart of the operations of the client for the above systems 10, 40, 60 and 100. In one embodiment, the client has a dual role of event sender and event receiver. The flow chart depicted in FIG. 7 illustrates the operations for this dual sending and receiving role. However, if the client operates as a host, it has the role of event sender, and the client only performs steps for sending events. If the client operates as only an event receiver, the client only performs steps for receiving events. At step 130, the client makes an HTTP connection to the server. As described above in conjunction with FIG. 2, the client makes the HTTP connection with the server by requesting a connection with the server and receiving an answer from the server. The connecting procedure may also include an authentication procedure, such as password confirmation. After the HTTP connection is established, the HTTP connection is kept open.

Once the HTTP connection exists between the client and the server, the client has two options from here onward that can be executed in parallel. The client can send events to the server that will later be sent to other clients through the server or the client can receive and process events that the server has sent. To send events, the client begins with step 132. At step 132, the client is in a processing state performing web applications such as viewing web pages. At step 134, the client decides whether to send an event. If the answer at step 134 is yes, the client proceeds to step 136 and sends the event to the server. After the event is sent, the client returns to the processing state of step 132. If the answer at step 134 is no, the client determines whether to quit the web application and terminates the HTTP connection at step 138. If the answer at step 138 is yes, the client ends the web application and terminates the HTTP connection, such as closing the browser. If the answer is not at step 138, the client returns to the processing state at step 132.

To receive and process events from the server, the client begins at step 140. At step 140, the client waits for events from the server. At step 142, the client determines whether an event has been received. If the answer at step 142 is yes, the client proceeds to step 144 and processes the event. After the event is processed, the client returns to the waiting state of step 140. If the answer at step 142 is no, the client determines whether to continue waiting for an event from the server at step 146. If the answer at step 146 is no, the client ends the web application and terminates the HTTP connection, such as closing the browser. If the answer is yes at step 146, the client returns to the waiting state at step 132.

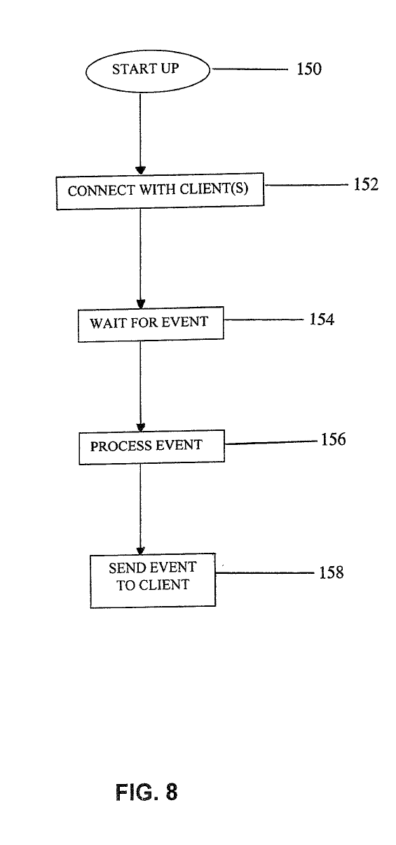

FIG. 8 illustrates a flow chart of the operations of the server for the above systems 60 and 100. The server begins with its start-up operations, and at step 150 the server makes the HTTP connection(s) to the client(s). As described above in conjunction with FIG. 2, the server receives the request for HTTP connection from the client and answers the request by forming the HTTP connection. The connecting procedure may also include an authentication procedure, such as password confirmation. As discussed in conjunction with FIG. 6 more than one client may establish the HTTP connection to the server. After the HTTP connection is established, the server keeps the HTTP connection open by occasionally sending some dummy information to the client to ensure that the client does not time out, such as a browser timing out. This channel should be kept open after contacting the client to ensure that the communication endures, but if it is defined that the client should reconnect to the server after the channel is closed, the server may in fact shut it down.

Once the HTTP connection exists between the client and the server or several HTTP connections exist between the server and numerous clients, the server waits for events at step 154. The events are HTTP requests received from the clients. After receiving an event, the server analyzes and processes the event at step 156. In the processing of the event, the server determines which connected clients should receive the event. After this determination, the server at step 158 sends the event in the form of an HTTP response to the client(s) through the channel(s) established during the connection process. For example, if the event is one client requesting that the event be sent to all other connected clients, the server sends the requested event to the other connected clients.

In one embodiment of the present invention, the system 60 as depicted in FIG. 4 is capable of implementing web chat and co-browsing. Web chat is the exchange of text messages between two clients, and co-browsing is the ability of one user to follow the other user when he navigates to another web page. The following examples of web chat and co-browsing are described in context with Altitude Software's Collaborator™ system; Altitude Software Inc. is the assignee of the present invention. Web chat and co-browsing assist a customer using a web site. At some point, the customer may have some questions regarding either the usage of the web site or any of the services available on the site. Instead of simply sending an email or telephoning a customer service center for the web site, the customer may use web chat and co-browsing with an agent of an Internet call center. The Internet call center includes a collaborator server and a plurality of agent computers each having a browser.

FIG. 9 illustrates a screen capture of a contact web page 160 displayed with a customer's browser. To display the web page shown in FIG. 9, the customer has selected to request assistance from the Internet call center associated with the web site. The request begins with the customer completing a request form 162 as illustrated in FIG. 9. On the request form 162, the customer enters personal information, including customer name in a “Your name” field 164, telephone number in a “Phone number” field 166 and email address in an “Email address” field 168. The customer also enters the subject matter for which they need assistance in a “Subject” field 170. In one embodiment, the “Subject” field 170 has a drop down list of typical problems and questions that the customer may select from or type in an unlisted description. The description of the problems listed in the “Subject” field 170 drop down list help agents quickly identify the problem.

Additionally, the customer selects a form of assistance in a “type of interaction” field 172 on the request form 162 as illustrated in FIG. 9. The types of interactions include co-browsing with web chat, co-browsing with an immediate call back, and a scheduled telephone call back. The request form 162 also includes a submit button 174 to send the request form 162 to the Internet call center, a close button 176 to exit the request form 162, and a “faq” button 178 to view more information about web collaboration service. Furthermore, the request form 162 includes an “Identifier” field 180 that allows the customer to reconnect with the same agent if for some reason the customer loses the connection with the agent during the collaboration session. After the collaboration session is interrupted, the agent may call the customer and give them a session ID code that appears on the agent's browser to represent the customer's collaboration session. The customer enters the session ID code in the “Identifier” field 180 to allow them to be reconnected into the session with the agent.

Once the customer has entered the information on the request form 162 and selected the send button 174, the information entered by the customer is transferred to the collaborator server associated with the Internet call center. The HTTP connection between the customer's browser and the collaborator server is established immediately after the customer submits the request form 160. Additional contact information is supplied to the collaborator server when the customer submits the request form 162 including the Internet address where the co-browse should begin and optionally a session identifier of the customer on that web site usually in the form of HTTP cookies. The collaborator server uses the cookies to maintain information between requests in the collaboration session. Cookies are a list of name-value pairs that are kept separate for each Internet site. If different cookies are provided for the same web page, different web content will be provided. Since the Internet call center web site is a different site from the web site that the customer wishes to co-browse with the agent, the customer provides these cookies.

After submitting the request form for web chat and/or co-browsing, the customer waits for an agent from the Internet call center to respond. During the wait, the customer has already established the HTTP connection to the collaborator server, so the customer receives information on the status of their request for assistance. For example, the collaborator server sends to the customer's browser an event comprising text describing the queue position and estimated wait time before an agent is available. The event provided by the server is performed in the manner described in conjunction with FIG. 2.

Once the collaborator server receives the information submitted with the request form 162, the collaborator server sends the information to an available or otherwise appropriate agent of the Internet call center. Typically, the Internet call center agent works on a personal computer having a browser with a network connection (LAN) to the collaborator server. In one embodiment, the agent's browser may connect to the collaborator server through the Internet. The agent's HTTP connection is established when the collaboration session is assigned to the agent by the collaborator server and the agent accepts the assignment.

Once the agent from the Internet call center establishes their HTTP connection to the server, the server sends events to the agent's browser. For example, once the server has received the request form 162 from the customer, the server sends an event to the agent comprising text describing the customer requesting assistance. The text may request the agent to call the customer immediately or at a specified time. Additionally, the text may describe the customer and list their specified problem.

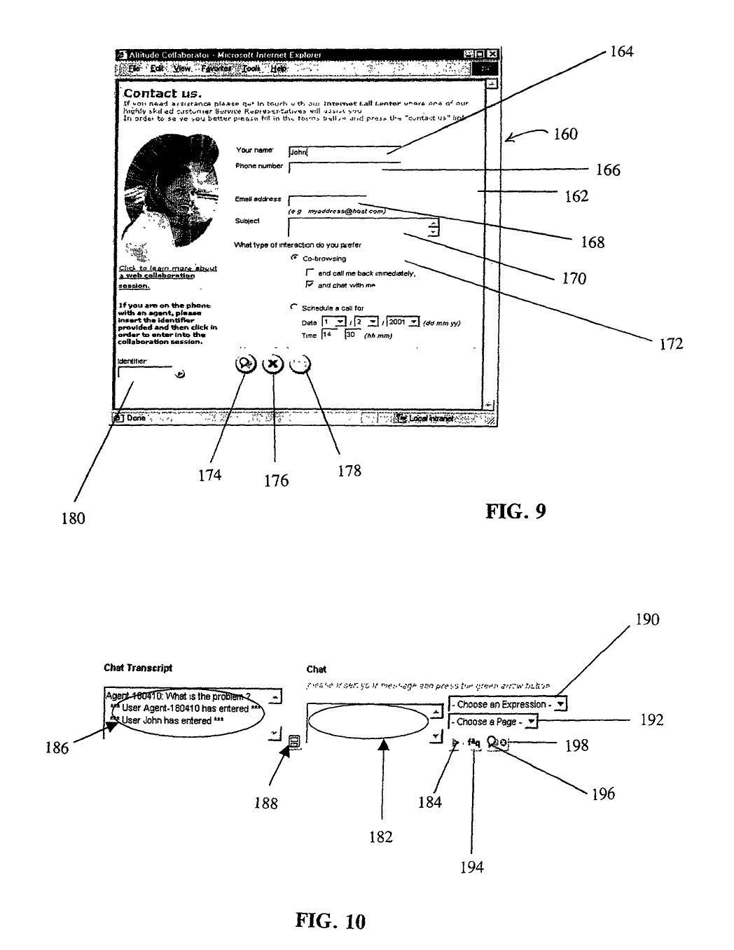

For web chat, the agent and customer communicate by exchanging text messages. In one embodiment, web chat starts automatically when the customer requests to collaborate with web chat as illustrated on the request form 162 in FIG. 9. Web chat can complement phone conversations; for example, agents can use web chat to give technical information while speaking on the telephone with the customer. FIG. 10 illustrates an example of web chat as illustrated on the agent's browser. For web chat, the customer or agents type in a message in the write area 182 and selects the send button 184 to transmit the message. The text typed in the write area 182 is placed in an event as a hidden HTTP request and is sent to the collaborator server. Then, the server sends the event as an HTTP response to the customer's browser resulting in the message being displayed on their browser. Each end user receives an event in the manner described above every time a message is sent.

In one embodiment for web chat, a chat transcript box 186 lists a concise history of the messages exchanged between the customer and agent. Additionally, the transcript listed in the box 186 may be sent via email by selecting a transcript send button 188. To assist the agent, an expression list box 190 lists useful expressions. The agent may select expressions from the expression list box 190 to quickly compose personal and accurate messages. For example, the agent can quickly insert the expression “Good Morning” from the list box 190. To further assist the agent, a page list box 192 contains a pre-defined list of links that the agent can push to the customer in order to quickly direct the customer to the desired web page that will be described in detail below in conjunction with co-browsing. Moreover, the agent selects a “faq” button 194 to obtain pre-defined answers to questions about the web site or business. By selecting the “faq” button 194, the agent obtains a list of answers designed to anticipate questions asked on the request form 162. The agent selects the end chat button 196 to end the web chat session. Additionally, the agent selects the close button 198 to close the web collaboration session. When the close button 198 is selected, the HTTP connection is also closed. Below, Table 3 illustrates a code example of web chat after the agent and customer have established their HTTP connections with the collaborator server. The chat message of Table 3 is “Hello, how are you?”

TABLE 3

| Agent's Browser to Server | Server to Agent's Browser | Server to Customer's Browser |
|---|---|---|
| Step 88 | | |
| Agent sends event (chat | | |
| message): | | |
| POST/iv/pusher/3434/chat | | |
| Cookie: | | |
| wc_session121212 | | |
| Cookie:wc_userid=454545 | | |
| line=Hello+how+are+you+ | | |
| %3F&command=send&req_ | | |
| id=3434 | | |
| | Step 90 | Step 92 |
| | Server confirms reception | Server also sends the |
| | of event by echoing the | chat message to the |
| | chat message sent: | customer's browser: |
| | --pusherScripts | --pusherScripts |
| | Content-type: text/html | Content-type: text/html |
| | <script | <script |
| | language=”JavaScript”> | language=”JavaScript”> |
| | iv_chatMessage(“peter”, | iv_chatMessage(“peter”, |
| | ”Hello how are you ?”); | ”Hello how are you ?”); |
| | </script> | </script> |

For co-browsing, the agent helps the customer navigate the web site. For example, the agent can help customers find specific products and information on the web site. During co-browsing the agent may push a web page to allow the customer to view the same page on their browser as displayed on the agent's browser. Also during co-browsing, the agent may pull a web page to allow the agent to view the same page on their browser as displayed on the customer's browser. For pushing a web page, the agent sends an event with the web site address through the server to the customer. The customer's browser processes the event and retrieves the pushed web page. In one embodiment, this request is handled by a web page caching mechanism in order to avoid duplicate page requests such as the original one and the one resulting from the web page push. For pulling a web page, the agent's browser sends an event through the server to the customer's browser that causes the customer's browser to respond with an event containing the web site address of the desired Web page. The agent's browser then retrieves that Web page by making a regular HTTP request handled by a web page caching mechanism. Pushing a page is a bit more complicated because of sites using HTML frames. In these cases, a set of URL-target frame pairs are sent. Below, Table 4 illustrates an HTTP code example of pushing and pulling a page in co-browsing after the agent and customer have established their HTTP connections with the collaborator server.

TABLE 4

| Agent's Browser to Server | Server to Agent's Browser | Server to Customer's Browser |
|---|---|---|
| Agent pushes his current | | |
| page to the customer: | | |
| POST/iv/pusher/6778/send | | |
| Cookie: wc_session=1212 | | |
| Cookie: wc_userid=5454 | | |
| script=iv_pushPage(“http:// | | |
| www.site.com/books/search”) | | |
| &confirm=false&req_id= | | |
| 6778 | | |
| | | Server sends the page push |
| | | event. The function |
| | | iv_pushPage, will be |
| | | evaluated by the browser and |
| | | force it to go the given URL: |
| | | --pusherScripts |
| | | Content-type: text/html |
| | | <script |
| | | language=”JavaScript”> |
| | | iv_pushPage(“http://www.site. |
| | | com/books/search”); |
| | | </script> |
| Agent request a page pull | | |
| from the customer: | | |
| POST/iv/pusher/6779/send | | |
| Cookie: wc_session1212 | | |
| Cookie: wc_userid=5454 | | |
| script=iv_pullPage( )&confirm= | | |
| false&req_id=6779 | | |
| | | Again the Server simply |
| | | forwards the script to the |
| | | browser: |
| | | --pusherScripts |
| | | Content-type: text/html |
| | | <script |
| | | language=”JavaScript”> |
| | | iv_pullPage( ); |
| | | </script> |
| | | This time the function |
| | | iv_pullPage will make a push |
| | | request of the customer's |
| | | current page. The rest is the |
| | | same: |
| | | POST/iv/pusher/6779/send |
| | | Cookie: wc_session=1212 |
| | | Cookie: wc_userid=5454 |
| | | script=iv_pushPage(“http://www. |
| | | site.com/music”)&confirm= |
| | | false&req_id=6779 |
| | Server sends the page push | |
| | event. | |
| | --pusherScripts | |
| | Content-type: text/html | |
| | <script | |
| | language=”JavaScript”> | |
| | iv_pushPage(“http://www.site. | |
| | com/music”); | |
| | </script> | |

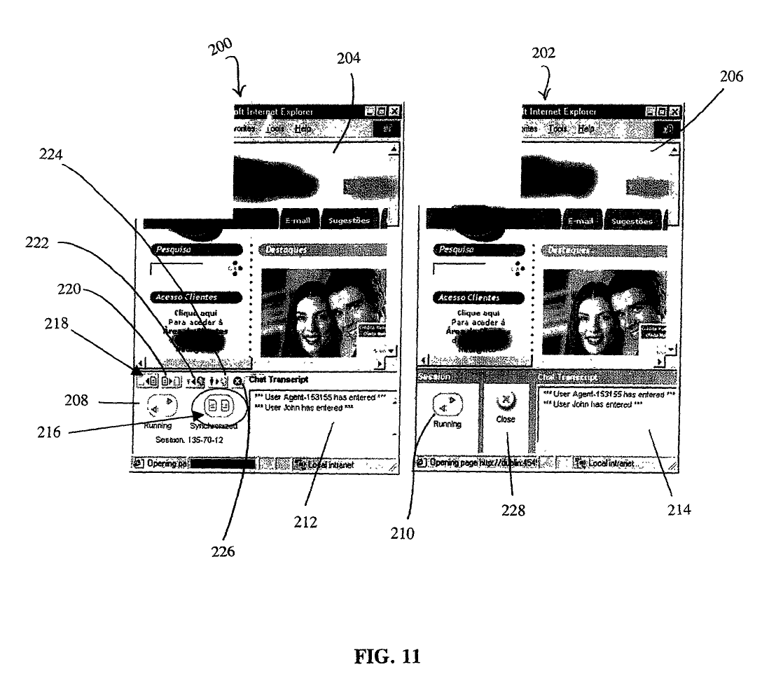

FIG. 11 illustrates a screen capture of the agent's display 200 and a screen capture of the customer's display 202 during a co-browsing session. As depicted in FIG. 11, the agent and customer are synchronized with both browsers displaying the identical web page 204, 206. Additionally, a session status 208, 210 indicates to both the agent and client that the co-browsing is running on their browsers. Both displays 200, 202 also show the chat transcript 212, 214. To assist the agent with co-browsing, the agent's browser displays a page status 216 that shows the agent and client are synchronized viewing the identical web page. To control the co-browsing session, the agent's browser provides control buttons 218, 220, 222, 224 to perform co-browsing operations. The agent may select a page pull button 218 to create and send an event causing the agent to display the same web page as is displayed on the customer's browser. The agent may select a page push button 220 to create and send an event causing the customer to display the same web page as is displayed on the agent's browser. The agent may select a follow me button 222 to create and send events causing the customer's browser to display what the agent's browser displays after each operation performed by the agent. The agent may select a follow the customer button 224 to create and send events causing the agent's browser to display what the customer's browser displays after each operation performed by the customer. Additionally, both the agent and customer displays 200, 202 have end session buttons 226, 228 to quit the co-browsing session.

Using the co-browsing features, an HTML form filling synchronization mechanism may be implemented. When both the agent's browser and the customer's browser have the same page, every time an input form value is changed on the host browser, the new value is sent as an event to the other browser. An event may be sent to the other browser for any user interaction, such as a key press or mouse movement. The agent provides this guidance as a dynamic demonstration of filling out the desired form. The customer may act upon the example in real time and preserve the current page with the completed form. Thus, when the agent completes the demonstration of form filling, the customer has fulfilled their objective of filling out the form. The present invention not only provides support for web application usage, but it also prevents error-prone miss-spellings from resulting in invalid data entering with the agent viewing the entries.

While particular embodiments and applications of the present invention have been illustrated and described, it is to be understood that the invention is not limited to the precise construction and compositions disclosed herein and that various modifications, changes and variations will be apparent from the foregoing descriptions without departing from the spirit and scope of the invention as defined in the appended claims.

What is claimed is:

1. A method for controlling a first HTTP client comprising:
establishing a first HTTP connection between said first HTTP client and an HTTP server; and
sending an event to said first HTTP client from said HTTP server over said HTTP connection without said HTTP server receiving a request for said event from said first HTTP client.

2. The method of claim 1 wherein said event comprises an HTTP response.

3. The method of claim 2 wherein said HTTP response includes text to be displayed on a display of said first HTTP client.

4. The method of claim 2 wherein said HTTP response includes a URL.

5. The method of claim 1 wherein said step of establishing said HTTP connection comprises said HTTP client requesting said connection and said HTTP server answering said request.

6. The method of claim 1 wherein said step of establishing said HTTP connection comprises said HTTP server sending a multi-part document.

7. The method of claim 1 further including said HTTP server maintaining said HTTP connection.

8. The method of claim 1 further including said first HTTP client processing said received event.

9. The method of claim 1 further including said first HTTP client sending a second event to said HTTP server after said first HTTP client has received said event from said HTTP server.

10. The method of claim 1 wherein said HTTP connection passes through an Internet.

11. The method of claim 1 wherein said first client is connected to a proxy server and said event passes through said proxy server.

12. The method of claim 1 wherein said event passes through a firewall.

13. The method of claim 1 wherein said first HTTP client is a browser.

14. The method of claim 1 further including a step of establishing a second HTTP connection between said HTTP server and a second HTTP client.

15. The method of claim 1 further including a step of sending a second client event from a second HTTP client to said first HTTP client.

16. The method of claim 15 wherein said second client event is first sent to said HTTP server and then passed to said first HTTP client.

17. The method of claim 15 wherein said second event comprises an HTTP request and an HTTP response.

18. The method of claim 15 further including said second HTTP client sending said second client event to said HTTP server, said HTTP server processing said second client event and said server sending a third event to said first HTTP client.

19. A method for controlling an HTTP client comprising:
sending an event to a HTTP client from a server without said server receiving a request for said event from said HTTP client, said event controlling said HTTP client.

20. The method of claim 19 further including the step of establishing an HTTP connection between said HTTP client and said server before sending said event.

21. The method of claim 19 farther including the step of sending a multi-part HTTP document from said server to said HTTP client before sending said event.

22. The method of claim 19 wherein said step of establishing said HTTP connection comprises said HTTP client requesting said connection and said server answering said request.

23. The method of claim 19 wherein said event comprises an HTTP response.

24. The method of claim 19 wherein said HTTP connection passes through an Internet.

25. The method of claim 19 further including sending a second event from a second HTTP client to said HTTP client, said second event controlling said HTTP client.

26. The method of claim 25 further including sending said second event from said second HTTP client to a third HTTP client, said second event controlling said third HTTP client.

27. A method for remotely controlling a first HTTP client by a second HTTP client, said method comprising:
establishing an HTTP connection between said first HTTP client and a second HTTP client,
sending an event to said first HTTP client from said second HTTP client over said HTTP connection, said event controlling said first client.

28. The method of claim 27 wherein said HTTP connection comprises a first HTTP connection between said first HTTP client and a server and a second HTTP connection between said second HTTP client and said server.

29. The method of claim 27 wherein said first HTTP client is a browser.

30. The method of claim 27 wherein said HTTP connection passes through an Internet.

31. The method of claim 27 wherein said event sent by said second client comprises an HTTP request and an HTTP response.

32. The method of claim 31 wherein said server processes an HTTP request portion of said event and passes an HTTP response portion of said event.

33. The method of claim 27 wherein said event is first sent to said server and passed to said first HTTP client.

34. The method of claim 27 wherein said event includes text to be displayed on a display of said first HTTP client.

35. The method of claim 27 wherein said event includes a URL.

36. The method of claim 27 wherein said second HTTP client acts as a host sending several events to said first HTTP client.

37. The method of claim 27 wherein said first HTTP client sends a second event to said second HTTP client.

38. A method for providing web site assistance for a customer browser, said method comprising:
establishing a first connection between said customer browser and a server,
establishing a second connection between an agent browser and said server; and
sending an event to said customer browser from said agent browser over said connections, said event controlling said customer browser.

39. The method of claim 38 wherein said first connection passes through an Internet.

40. The method of claim 38 wherein said event is first sent to said server and passed to said customer browser.

41. The method of claim 40 further including said server processing an HTTP request portion of said event and passing an HTTP response portion of said event to said customer browser.

42. The method of claim 38 wherein said event includes text to be displayed by said customer browser.

43. The method of claim 38 wherein said event includes a URL of a web page to be displayed by said customer browser.

44. The method of claim 38 further including said customer browser sending a second event to said agent browser.

45. The method of claim 44 wherein said event and said second event comprise text message for a web chat between said customer browser and said agent browser.

46. The method of claim 38 wherein said event comprise a URL for a co-browse said customer browser and said agent browser.

47. The method of claim 38 further including the step of providing a list of web chat texts on said agent browser and allowing said agent to select one of said web chat texts to send as said event.

48. A method for pushing a web page to a customer browser, said method comprising:
creating a first connection between said customer browser and a server, creating a second connection between an agent browser and said server;
sending an event comprising a URL of said web page displayed on said agent browser to said customer browser from said agent browser over said connections; and
processing said event by said customer browser causing said customer browser to request said URL and display said web page.

49. The method of claim 48 further including the steps of performing an action on said web page by said agent browser, sending a second event comprising said action from said agent browser to said customer browser, processing said second event by said customer browser to display said action.

50. The method of claim 48 further including the steps of performing an action on said web page by said customer browser, sending a third event comprising said action from said customer browser to said agent browser, processing said third event by said agent browser to display said action.

51. A method for pulling a web page from a customer browser, said method comprising:
creating a first connection between said customer browser and a server,
creating a second connection between an agent browser and said server;
sending a first event to said customer browser from said agent browser over said connections;
processing said first event by said customer browser, said event causing said customer browser to generate a second event comprising a URL of said web page;
sending said second event to said agent browser from said customer browser over said connections; and
processing said second event by said agent browser, said second event causing said agent browser to go to said URL and display said web page on an agent display.

52. The method of claim 51 further including the steps of performing an action on said web page by said customer browser, sending a third event comprising said action from said customer browser to said agent browser, processing said third event by said agent browser to display said action.

53. The method of claim 51 further including the steps of performing an action on said web page by said agent browser, sending a third event comprising said action from said agent browser to said customer browser, processing said third event by said customer browser to display said action.

54. A system for controlling a first client comprising a server capable of establishing a connection with said first client and sending an event to said first client without said first client requesting said event, said event controlling said first client.

55. The system of claim 54 wherein said event comprises an HTTP response.

56. The system of claim 54 wherein said server establishes said connection by answering a connection request received from said first client.

57. The system of claim 54 wherein said server establishes said connection by sending a multi-part HTTP response to said first client.

58. The system of claim 54 wherein said server is further capable of receiving a second event from said first client.

59. The system of claim 58 wherein said second event comprises an HTTP request.

60. The system of claim 54 wherein said connection passes through an Internet.

61. The system of claim 54 wherein said server is further capable of establishing a second connection with a second client and receiving a second event from said second client, said server sends said second event to said first client, said second event controls said first client.

62. The system of claim 61 wherein said server receives said second event and processes an HTTP request portion of said second event and sends an HTTP portion of said second event to said first client.

63. The system of claim 62 wherein said server is capable of establishing a third connection with a third client and receiving a second event from said second client, said server sends said second event to said first client and said third client, said second event controls said first client and said third client.
